(19) United States
(12) Patent Application Publication
(10) Pub. No.: US 2003/0147541 A1
(43) Pub. Date: Aug. 7, 2003

(54) Flat-panel loudspeaker

(76) Inventors: Wolfgang Bachmann, Grevenbroich (DE); Gerhard Krump, Schwarzach (DE); Hans-Jurgen Regl, Regensburg (DE); Andreas Ziganki, Mettmann (DE)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/240,124

(22) PCT Filed: Jan. 26, 2001
(86) PCT No.: PCT/EP01/00858

(51) Int. Cl. H04R 25/00

(52) U.S. Cl. 381/152

(57) ABSTRACT

A panel loudspeaker with a low mass panel, a holder for retaining the panel and at least one driver with a vibrating connection to the panel for producing mechanical vibrations as a function of electrical drive signals, where the panel is bent at least in one dimension.

Loudspeakers which use a flat diaphragm instead of the conventional conical diaphragm are known. The upper operating frequency of such loudspeakers, called panel loudspeakers, is determined by the so-called “break-up”, meaning the occurrence of the first bending vibration resonance to be avoided.

It is furthermore known that the feared bending wave resonances in cone loudspeakers are not considered to be altogether detrimental for panel loudspeakers. With corresponding excitation and clamping techniques, and the selection of a suitable material and plate structure, the essentially feared bending vibration resonances can even enhance the main part of the sound event and actually produce a pleasant sound experience.

Furthermore panel loudspeakers with bending vibration resonances are known, the so-called multiresonance panel loudspeakers. Multiresonance panel loudspeakers have a “flatness” appeal for the user, meaning they are clearly less thick than the usual boxes. The reproduction in the high and medium sound range is satisfactory.

The bass response is a problem however because of the known dipole short circuit in an open panel. A possible remedy for example is to use a flat housing to close the back of the panel, which however partially cancels the advantages of a self-supporting panel without a housing.

Another problem is also the pulse reproduction in panel loudspeakers. The larger the panel the softer it becomes. This lowers the impedance in the bass response. The driver deflection leaves the linear range and in extreme cases strikes the limits of the magnetic system in an undesirable manner.

The object of the invention is to propose a multiresonance panel loudspeaker, particularly one with improved bass tones properties despite a large surface and a small depth.

The object is achieved by a panel loudspeaker as claimed in claim 1. Configurations and further developments of the inventive idea are the subject of subclaims.

In addition to improved bass response, the panel loudspeaker of the invention excels above all with a dipole cut-off frequency which is lower than provided by the short edge length. Beyond that the invented panel loudspeaker does not strike, not even under extreme pulse load.

This is achieved by a low mass panel loudspeaker, a holder for retaining the panel and at least one driver with a vibrating connection to the panel for producing mechanical vibrations as a function of electrical drive signals, where the panel is bent in at least one dimension. The invention enables a change in the bending stiffness of panels in selected directions by providing a corresponding shape. The influence of a panel's acoustical parameters on the bending stiffness also makes it possible to use unfavorable aspect ratios.

Another improvement of the acoustical properties is achieved by straining the panel. Tension can be provided internally by corresponding manufacturing processes when the panel is formed, or externally with forces exerted by suitable outside means.

Beyond that it is preferred to arrange the panel so that it can be excited by the driver into multiple reflected bending waves. In that case the panel is preferably located in a gasketed holder which keeps it essentially self-supporting and low damping.

Several drivers can also be provided, where the polarity of the drivers is linked to the sign of the bend in the panel, preferably so that with corresponding excitation by the drivers a sound transduction takes place in the audio frequency range both above and below the critical frequency, and/or both above and below the bending wave resonance. In a further development of the invention the panel is composed of seamlessly assembled rows of profile sections. This allows panels of nearly any size to be constructed in a simple manner. It is preferred if panels which are bent in one dimension have identical profile sections, so that cost of producing the profile sections can be significantly reduced. Panels bent in two dimensions advantageously do not need identical profile sections, for example to produce particularly stable and/or heavily bent panels. The bending radii are preferably chosen so that they correspond at least to the size of the edge lengths.

In a further development of the invention the holder is gasketed so that at least one edge is tightly sealed when it contacts a surface provided for attaching the panel. This mostly prevents the undesirable dipole effect. To that end for example at least one edge is equipped with a sealing lip, so that it is tightly sealed when it contacts a wall, a ceiling or the floor.

Finally, the panel of a panel loudspeaker according to the invention can be formed by a correspondingly constructed internal panel element of an automobile. The acoustically desirable bends can also be a design element of the internal panel element.

The invention will be explained in greater detail in the following by means of embodiments illustrated by the figures in the drawings, where:

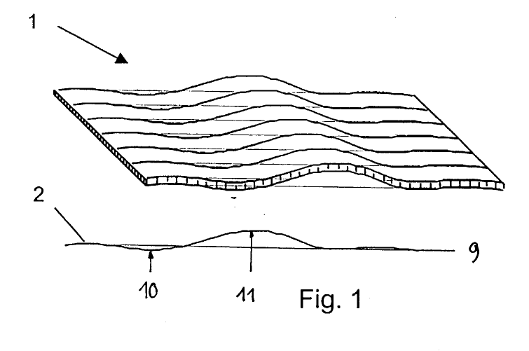

FIG. 1 Is a first embodiment of a panel loudspeaker according to the invention with a panel bent in one dimension.

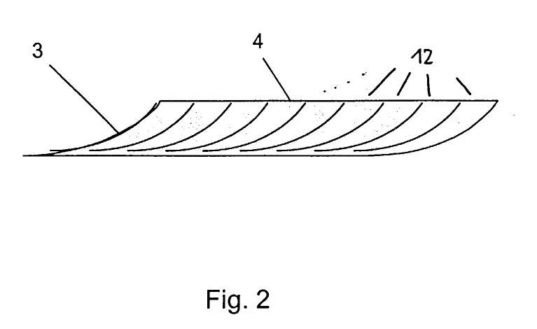

FIG. 2 is a second embodiment with a panel bent in one dimension.

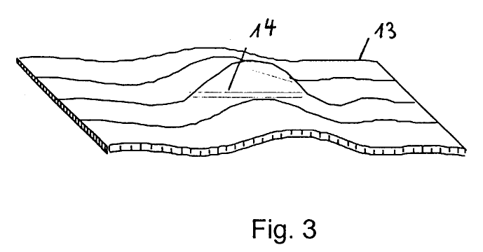

FIG. 3 is a third embodiment of a panel loudspeaker according to the invention with a panel bent in two dimensions.

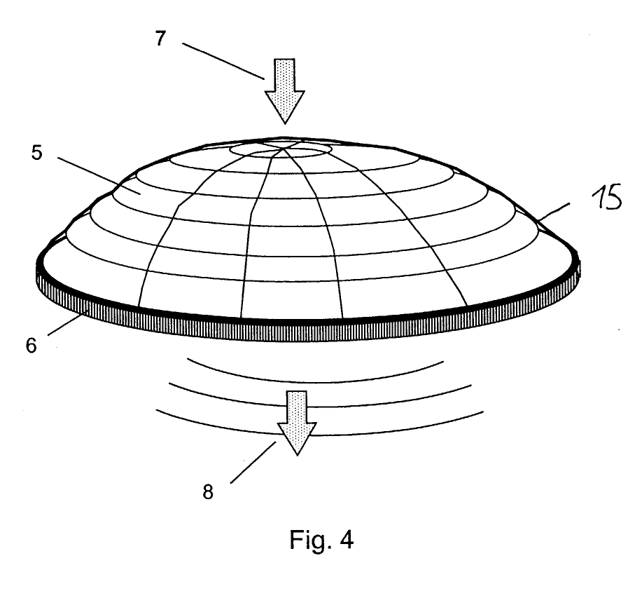

FIG. 4 is a fourth embodiment with a panel bent in two dimensions, and

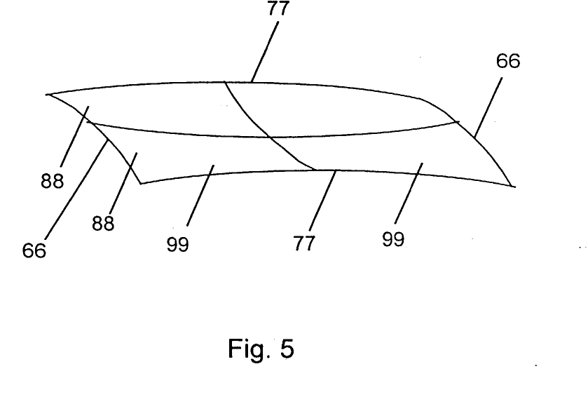

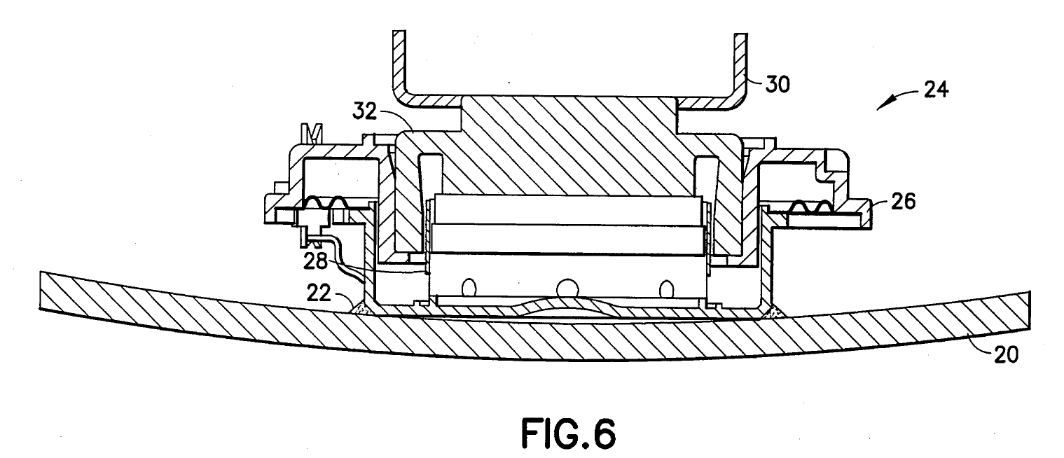

FIG. 5 is a fifth embodiment with a panel having a natural anisotropic shape.

The embodiment shown in FIG. 1 is a rectangular panel 1 with a length-to-width ratio >1 and a one-dimensional bend in the lengthwise direction. The bend is configured so that, starting from a zero position 9 in the planar panel, it is bent in both the positive and the negative direction vertically to the panel surface. Thus the course of the bend 2 has negative and positive amplitudes with respect to the zero position 9. For example if drivers are installed on the panel 1 in the areas with the greatest negative (10) and the greatest positive (11) deviation from the zero position 9, they will operate in phase opposition to each other. The drivers are not shown in the drawing for reasons of better clarity.

FIG. 2 in turn represents a rectangular panel 4 with a length-to-width ratio >1. Here the bend in the panel 4 differs from the embodiment in FIG. 1, it is vertical to the lengthwise direction. Beyond that the panel 4 is composed of seamlessly assembled rows of identical profile sections 12, which are for example cemented to each other in the joint areas. In this case the bending radius 3 has at least the same order of magnitude as the pertinent edge length.

FIG. 3 shows a rectangular panel 13 with a length-to-width ratio >1, which has a bending course in both the lengthwise direction as well as vertically thereto, with bends in both the negative and in the positive direction from a zero position 14 (corresponding to a planar panel). The bending course in the lengthwise direction is wavelike, while it is hump-shaped across the lengthwise direction in the central part of the panel 13. Here as well all bending radii also have at least the same order of magnitude as the edge lengths.

The panel used in the embodiment of FIG. 4 has a circular base and is bent so that it has an approximately spherical shape. The panel 15 has low mass and is arranged in a gasketed holder 6 to be mainly self-supporting and low damping, so that it can be excited into multiple reflected bending waves by a driver not illustrated in the drawing (multiresonance sound plate). The panel itself is composed of seamlessly assembled rows of nonidentical profile sections 5, where all bending radii have at least the same order of magnitude as the edge lengths. The small profile sections 5 could be replaced with larger, identical profile sections formed of sphere segments. The gasket of holder 6 is located on the lower edge and forms a tight seal when it contacts a wall, a ceiling or the floor. The panel 15 is strained both externally 7 as well as internally 8. For example the external force is applied to the central point of the sphere by a spring element or similar, while the internal tension for example is produced by the tight assembly of the profile sections 5.

All the shown panels are used as panels in the passenger, cabin of vehicles, such as for example the door panel, the ceiling panel or parts of the instrument panel in a passenger car. This allows the use of locally heavy bends and damping anchor points. Otherwise self-supporting panels with low damping and a gasketed holder are preferred.

It can furthermore be provided that individual areas, which are predetermined or optimized for the reproduction of different frequency ranges, can be separated or uncoupled from each other by means of corresponding radii inside a large bent profile section. These areas are equipped with optimum drivers (for bass, middle or high tones) and can be uncoupled from each other for example because relatively small radii separate the respective profile section areas. These radii stiffen the large panel and thus divide it into the different areas. This prevents most overlapping of the bending waves from different areas.

Finally another configuration provides for a panel to be bent into a cylinder, or to be assembled of several segments to create a cylinder, which can then be used as a panoramic radiator for different acoustic room exposures. Segments can also be assembled into a spherical radiator panel.

FIG. 5 shows a 3-dimensional form variation. As the core of a future sandwich panel, a flat honeycomb which originally had a rectangular shape takes on its own shape from the static reaction to a pair of bending moments striking two opposite edges, due to anisotropy of the elastic constants of the honeycomb; its first mode is illustrated in FIG. 5. The four edges 66 and 77 have the same bending sign. A central area which is delimited by four unbent neutral fibers 88 and 99, has opposite bending signs throughout. This behavior remains, even if the corners are cut or rounded off.

Thus by using the corresponding compression molds, 3-dimensionally bent honeycomb sandwiches can be produced with hot or cold-cemented cover sheets, without damaging the honeycomb structure.

1. A panel loudspeaker with a low mass panel, a holder for retaining the panel and at least one driver with a vibrating connection to the panel for producing mechanical vibrations as a function of electrical drive signals, characterized in that the panel is bent in at least one dimension.

2. A panel loudspeaker as claimed in claim 1, characterized in that the panel is under tension.

3. A panel loudspeaker as claimed in claim 1 or 2, characterized in that the panel is arranged so that the driver can excite it into multiple reflected bending waves.

4. A panel loudspeaker as claimed in one of claims 1 to 3, characterized in that several drivers are provided, where the polarity of the drivers is linked to the sign of the bend in the panel.

5. A panel loudspeaker as claimed in one of claims 1 to 4, characterized in that the linkage is such that a corresponding excitation by the drivers produces a sound transformation in the audio frequency range both above and below the critical frequency.

6. A panel loudspeaker as claimed in one of claims 4 or 5, characterized in that the linkage is such that a corresponding excitation by the drivers produces a sound transformation in the audio frequency range both above and below the bending wave frequency.

7. A panel loudspeaker as claimed in one of claims 1 to 6, characterized in that the panel is bent in one dimension and the panel is composed of seamlessly assembled rows of identical profile sections.

8. A panel loudspeaker as claimed in claim 7, characterized in that the panel is bent in two dimensions, and that the panel is assembled of seamless rows of profile sections.

9. A panel loudspeaker as claimed in claim 8, characterized in that the profile sections are not identical.

10. A panel loudspeaker as claimed in claim 7, 8 or 9, characterized in that the bending radii have at least the same order of magnitude as the edge lengths.

11. A panel loudspeaker as claimed in one of claims 2 to 10, characterized in that the panel is pretensioned internally.

12. A panel loudspeaker as claimed in one of claims 2 to 10, characterized in that the panel is pretensioned externally.

13. A panel loudspeaker as claimed in one of claims 1 to 12, characterized in that the holder for the panel is gasketed.

14. A panel loudspeaker as claimed in claim 13, characterized in that at least one edge of the holder is constructed so that it is tightly sealed when it contacts a panel installation surface.

15. A panel loudspeaker as claimed in one of claims 1 to 14, characterized in that the panel is made of an internal panel element of an automobile.

16. A panel loudspeaker as claimed in one of claims 1 to 15, characterized in that the panel has an anisotropic shape.

17. A panel loudspeaker with a low mass panel, a holder for retaining the panel and at least one driver with a vibrating connection to the panel for producing mechanical vibrations as a function of electrical drive signals, characterized in that the panel is shaped so that its bending strength in selected space directions is different.
